(19) United States
(12) Patent Application Publication
(10) Pub. No.: US 2025/0033033 A1
(43) Pub. Date: Jan. 30, 2025

(54) Pipette

(71) Applicant: NIPRO CORPORATION, Settsu-shi, Osaka (JP)

(72) Inventors: Yoshihiro YOSHIKAWA, Settsu-shi, Osaka (JP); Masayuki TOYOSHIMA, Settsu-shi, Osaka (JP); Ryosuke NAKAMURA, Settsu-shi, Osaka (JP); Kazunari ABE, Settsu-shi, Osaka (JP)

(21) Appl. No.: 18/713,779

(22) PCT Filed: Dec. 26, 2022
(86) PCT No.: PCT/JP2022/047846

§ 371 Date: May 28, 2024

(30) Foreign Application Priority Data
Dec. 27, 2021 (JP) 2021-213385

(51) Int. Cl. B01L 3/02

(52) U.S. Cl. CPC B01L 3/021; B01L 2200/0605

(57) ABSTRACT

To make liquid unlikely to drip from a pipette when the pipette is tilted. A pipette includes a main body portion, a tapered portion, and a distal end portion. The main body portion has a hollow cylindrical shape. The tapered portion has a hollow cylindrical shape, and extends further than a distal end of the main body portion in a distal direction. An inner diameter of a proximal end of the tapered portion is less than or equal to an inner diameter of the distal end of the main body portion. The tapered portion has an inner diameter decreasing in the distal direction. The distal end portion has a hollow cylindrical shape, extends from a distal end of the tapered portion in the distal direction, and has an inner diameter that is less than or equal to an inner diameter of the distal end of the tapered portion.

### TECHNICAL FIELD

The present invention relates to a pipette.

### BACKGROUND ART

As a pipette, that described in Patent Document 1 is known, for example. The pipette of Patent Document 1 includes a main body portion having a hollow cylindrical shape and a tip end portion formed at a tip end of the main body portion. The tip end portion has a hollow conical shape. An inner diameter of the tip end portion decreases from a point joined to the main body portion toward a tip end.

### PRIOR ART DOCUMENT

### Patent Document

Patent Document 1: Japanese Patent Application Laid-Open No. 2015-192989

### SUMMARY OF THE INVENTION

### Problems to be Solved by the Invention

In the above-mentioned pipette, the inner diameter of the tip end portion greatly increases from an opening at the tip end toward the main body portion. Therefore, when an operator tilts the pipette from a vertical posture, a meniscus of liquid at the opening at the tip end is likely to break. There is a problem that the liquid drips from the opening of the pipette if the meniscus breaks.

The present invention has been made in view of the above-mentioned circumstances, and an object thereof is to make liquid unlikely to drip from a pipette when the pipette is tilted.

### Means for Solving the Problems

(1) A pipette according to the present invention includes a main body portion having a hollow cylindrical shape, a tapered portion having a hollow cylindrical shape, extending further than a distal end of the main body portion in a distal direction, and having an inner diameter of a proximal end that is less than or equal to an inner diameter of the distal end of the main body portion and an inner diameter decreasing in the distal direction, and a distal end portion having a hollow cylindrical shape, extending from a distal end of the tapered portion in the distal direction, and having an inner diameter that is less than or equal to an inner diameter of the distal end of the tapered portion.

According to the present invention, since provided is the distal end portion having the hollow cylindrical shape, extending from the distal end of the tapered portion in the distal direction, and having the inner diameter that is less than or equal to the inner diameter of the distal end of the tapered portion, a meniscus of liquid at an opening at a distal end of the distal end portion is unlikely to break even if an operator tilts the pipette from a vertical posture. Therefore, the liquid is unlikely to drip from the pipette when the operator tilts the pipette.

(2) The inner diameter of the distal end portion may be within a range of 3.0 mm or more and 3.5 mm or less.

In the above pipette, as the inner diameter of the distal end portion is made smaller, the meniscus of the liquid at the opening at the distal end of the distal end portion becomes more unlikely to break, while a flow resistance at the distal end portion becomes larger, thus an internal pressure becomes likely to be applied to the pipette when a discharge of the liquid from the distal end portion is stopped by an air pressure of the main body portion. Therefore, there occurs a problem that dripping in which the liquid drips little by little from the opening of the distal end portion continues, and the liquid more than an expected amount is discharged. In the above configuration, since the inner diameter of the distal end portion is 3.0 mm or more, the flow resistance at the distal end portion does not become excessively large. Therefore, dripping is suppressed when the discharge of the liquid from the pipette is stopped. In the above configuration, since the inner diameter of the distal end portion is 3.5 mm or less, the meniscus of the liquid at the opening at the distal end of the distal end portion becomes unlikely to break. Therefore, even if the pipette is tilted from the vertical posture, the meniscus of the liquid at the opening at the distal end of the distal end portion becomes unlikely to break, and dripping is suppressed when the pipette is tilted.

(3) A length of the distal end portion along the distal direction may be within a range of 25 mm or more and 60 mm or less.

Since the length of the distal end portion along the distal direction is 25 mm or more, the meniscus of the liquid at the opening at the distal end of the distal end portion becomes unlikely to reach the tapered portion even if the pipette is tilted from the vertical posture. Therefore, the meniscus of the liquid becomes unlikely to break even if the operator tilts the pipette, and dripping is suppressed when the pipette is tilted. Since the length of the distal end portion along the distal direction is 60 mm or less, an increase in an overall length of the pipette along the distal direction is suppressed, and a deterioration of an operability of the pipette is suppressed.

(4) A taper angle of the tapered portion may be 40 degrees or less.

As the taper angle of the tapered portion becomes larger, the flow resistance of the liquid suctioned up toward the main body portion through the opening of the distal end portion becomes smaller rapidly in the tapered portion, thus the liquid becomes more likely to blow up in the tapered portion. Due to the blow up of the liquid, the liquid may adhere to an inner surface of the main body portion or bubbles may be generated, and an amount of the liquid may be unlikely to be obtained accurately with a scale of the main body portion, or the like. In the above configuration, since the taper angle of the tapered portion is 40 degrees or less, a rapid decrease in the flow resistance of the suctioned-up liquid in the tapered portion is suppressed. Therefore, the blow up of the suctioned-up liquid is suppressed.

(5) The inner diameter of the proximal end of the tapered portion may be 7.0 mm or more.

Since a flow rate of the liquid at the proximal end of the tapered portion becomes slow, the blow up of the liquid is suppressed when the suctioned-up liquid flows from the tapered portion into the main body portion.

(6) A capacity of the pipette may be within a range of 10 ml or more and 100 ml or less.

The pipette can hold more liquid than a micropipette.

(7) An attachment portion to which an electric intake and exhaust device can be attached may be provided at an end portion of a proximal end side of the main body portion.

An operator can suction up or discharge the liquid easily by attaching the electric intake and exhaust device to the attachment portion of the main body portion.

### Effects of the Invention

According to the present invention, the liquid is unlikely to drip from the pipette when the pipette is tilted.

### BRIEF DESCRIPTION OF THE DRAWINGS

FIG. 1 is a cross-sectional view of a pipette 1, taken along a plane including a center line C.

FIG. 2 is a perspective view of the pipette 1.

### MODES FOR CARRYING OUT THE INVENTION

Hereinafter, a preferred embodiment of the present invention will be described. Note that the present embodiment is merely one embodiment of the present invention, and it goes without saying that the embodiment can be modified without changing the gist of the present invention.

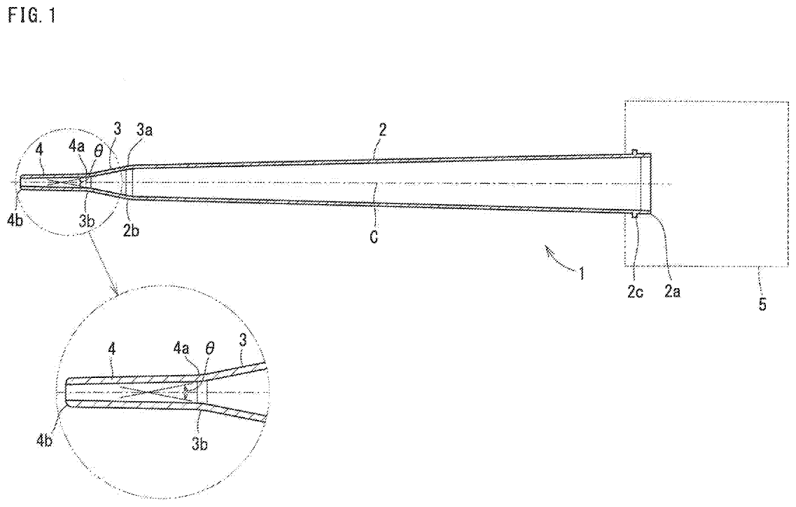

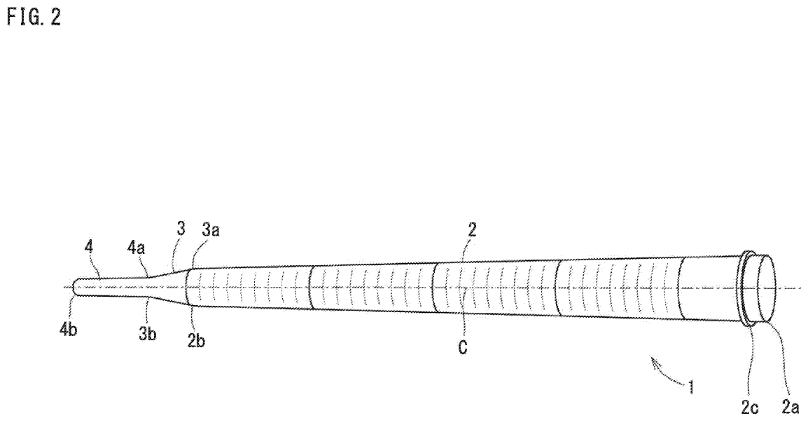

As shown in FIGS. 1 and 2, a pipette 1 includes a main body portion 2, a tapered portion 3, and a distal end portion 4. The main body portion 2 is formed in a hollow cylindrical shape having an inner diameter decreasing slightly from a proximal end 2a toward a distal end 2b. Note that the main body portion 2 may be formed in a hollow cylindrical shape having the same inner diameter from the proximal end 2a to the distal end 2b. Furthermore, an inward flange extending radially inward from the distal end 2b may be formed on the main body portion 2. A scale may be provided to the main body portion 2. The main body portion 2 is preferably sized so that a capacity of the pipette 1 falls within a range between 10 ml or more and 100 ml or less, is more preferably sized so that the capacity of the pipette 1 falls within a range of 25 ml or more and 75 ml or less, and is particularly preferably sized so that the capacity of the pipette 1 falls within a range of 30 ml or more and 50 ml or less. If the capacity of the pipette 1 is 10 ml or more, the pipette 1 can hold more liquid than a micropipette. If the capacity of the pipette 1 is 100 ml or less, it is easy for an operator to perform suction/discharge operations of the liquid with holding the main body portion.

The main body portion 2 has, at an end portion on a proximal end 2a side, an attachment portion 2c to which an electric intake and exhaust device 5 can be attached. The attachment portion 2c has a shape that protrudes from an outer peripheral surface of the main body portion 2 and continues in a circumferential direction. The operator can suction up or discharge the liquid easily by attaching the electric intake and exhaust device 5 to the attachment portion 2c of the main body portion 2.

A suction/discharge speed of an auto pipettor in which the intake and exhaust device 5 is attached to the attachment portion 2c is preferably within a range of 1 ml/s or more and 10 ml/s or less, is more preferably within a range of 3 ml/s or more and 10 ml/s or less, and is particularly preferably within a range of 5 ml/s or more and 10 ml/s or less. If the suction/discharge speed of the auto pipettor is 1 ml/s or more, suction/discharge time of the liquid can be shortened. If the suction/discharge speed of the auto pipettor is 10 ml/s or less, a blow up or a bounce back of the liquid can be suppressed when the liquid is suctioned or discharged.

The tapered portion 3 extends from the distal end 2b of the main body portion 2 in a distal direction. An inner diameter of a proximal end 3a of the tapered portion 3 is equal to an inner diameter of the distal end 2b of the main body portion 2. The tapered portion 3 is formed in a hollow cylindrical shape having an inner diameter decreasing from the proximal end 3a toward a distal end 3b. An internal space of the tapered portion 3 communicates with an internal space of the main body portion 2. Note that the tapered portion 3 only needs to extend further than the distal end 2b of the main body portion 2 in the distal direction. For example, the tapered portion 3 may extend in the distal direction from an inner end of the inward flange formed at the distal end 2b of the main body portion 2. In this case, the inner diameter of the proximal end 3a of the tapered portion 3 is smaller than the inner diameter of the distal end 2b of the main body portion 2.

A taper angle θ of the tapered portion 3 is larger than a taper angle of the main body portion 2. The taper angle θ is an angle formed by portions of an inner circumferential surface of the tapered portion 3, the portions located at positions of 180 degrees with respect to a center line C (see FIG. 1).

As the taper angle θ of the tapered portion 3 becomes larger, a flow resistance of the liquid suctioned up into the pipette 1 becomes smaller rapidly in the tapered portion 3.

Therefore, the suctioned-up liquid becomes more likely to blow up in the tapered portion 3. Since the liquid may adhere to an inner surface of the main body portion 2 or bubbles may be generated due to the blow up of the liquid, in this case, an amount of the liquid becomes unlikely to be accurately obtained with the scale of the main body portion 2, or the like. In the present embodiment, the taper angle θ of the tapered portion 3 is within a range of 6 degrees or more and 40 degrees or less, is preferably within a range of 15 degrees or more and 35 degrees or less, and is more preferably within a range of 20 degrees or more and 30 degrees or less. If the taper angle θ is 40 degrees or less, since a rapid decrease in the flow resistance of the liquid suctioned up into the pipette 1 in the tapered portion 3 is suppressed, the blow up of the liquid in the tapered portion 3 can be suppressed. If the taper angle θ is 6 degrees or more, since an increase in a length of the tapered portion 3 along the distal direction can be suppressed, an increase in an overall length of the pipette 1 along the distal direction can be suppressed, and an operability of the pipette 1 is improved.

An inner diameter of the tapered portion 3 is less than or equal to the inner diameter of the distal end 2b of the main body portion 2. In the present embodiment, the inner diameter of the proximal end 3a of the tapered portion 3 is equal to the inner diameter of the distal end 2b of the main body portion 2.

Here, if the inner diameter of the proximal end 3a of the tapered portion 3 is smaller than the inner diameter of the distal end 2b of the main body portion 2, the liquid becomes likely to blow up when the suctioned-up liquid flows from the tapered portion 3 into the main body portion 2. In this case, as the inner diameter of the proximal end 3a of the tapered portion 3 becomes smaller compared to the inner diameter of the distal end 2b of the main body portion 2, a flow rate of the liquid when the suctioned-up liquid flows from the tapered portion 3 into the main body portion 2 becomes faster, thus the liquid becomes more likely to blow up.

In the present embodiment, the inner diameter of the proximal end 3a of the tapered portion 3 is preferably within a range of 7.0 mm or more and 25 mm or less, is more preferably within a range of 8.0 mm or more and 20 mm or less, and is particularly preferably within a range of 10 mm or more and 15 mm or less. If the inner diameter of the proximal end 3a of the tapered portion 3 is 7.0 mm or more, since the flow rate of the liquid at the proximal end 3a of the tapered portion 3 becomes slow, the blow up of the liquid can be suppressed when the suctioned-up liquid flows from the tapered portion 3 into the main body portion 2. If the inner diameter of the proximal end 3a of the tapered portion 3 is 25 mm or less, the increase in the length of the tapered portion 3 along the distal direction can be suppressed. Therefore, the increase in the overall length of the pipette 1 along the distal direction can be suppressed, thus the operability of the pipette 1 is improved.

The distal end portion 4 extends from the distal end 3b of the tapered portion 3 in the distal direction. The distal end portion 4 is formed into a hollow cylindrical shape having an inner diameter decreasing slightly from a proximal end 4a toward a distal end 4b. Note that the distal end portion 4 may be formed in a hollow cylindrical shape having the same inner diameter from the proximal end 4a to the distal end 4b. An internal space of the distal end portion 4 communicates with the internal space of the tapered portion 3. A taper angle of the distal end portion 4 is smaller than the taper angle θ of the tapered portion 3. An inner diameter of the distal end portion 4 is less than or equal to an inner diameter of the distal end 3b of the tapered portion 3. In the present embodiment, the inner diameter of the proximal end 4a of the distal end portion 4 is equal to the inner diameter of the distal end 3b of the tapered portion 3, and a difference between the inner diameter of the proximal end 4a and an inner diameter of the distal end 4b is 1 mm. Since the distal end portion 4 is formed at the distal end 3b of the tapered portion 3, a meniscus of the liquid at an opening at the distal end 4b of the distal end portion 4 is unlikely to break. Therefore, the liquid is unlikely to drip from the pipette 1 even if the operator tilts the pipette 1.

As the inner diameter of the distal end 4b of the distal end portion 4 is made smaller, the meniscus of the liquid at the opening at the distal end 4b of the distal end portion 4 becomes more unlikely to break, while a flow resistance at the distal end portion 4 becomes larger, thus an internal pressure becomes more likely to be generated in the pipette 1 when a discharge of the liquid from the distal end portion 4 is stopped by an air pressure of the main body portion 2. Therefore, there occurs a problem that after the discharge of the liquid is stopped, dripping in which the liquid continues to drip little by little from the opening of the distal end portion 4 continues and the liquid more than an expected amount is discharged.

In the present embodiment, the inner diameter of the distal end 4b of the distal end portion 4 is within a range of 3.0 mm or more and 3.5 mm or less, is preferably within a range of 3.0 mm or more and 3.3 mm or less, and is more preferably within a range of 3.0 mm or more and 3.1 mm or less. If the inner diameter of the distal end 4b of the distal end portion 4 is 3.0 mm or more, the flow resistance of the liquid at the distal end portion 4 does not become excessively large, thus the internal pressure becomes unlikely to be generated in the pipette 1 when the discharge of the liquid from the distal end portion 4 is stopped by the air pressure of the main body portion 2. Therefore, dripping is suppressed when the discharge of the liquid is stopped. If the inner diameter of the distal end 4b of the distal end portion 4 is 3.5 mm or less, the meniscus of the liquid at the opening at the distal end 4b of the distal end portion 4 becomes unlikely to break. Therefore, the meniscus of the liquid becomes unlikely to break even if the pipette 1 is tilted from a vertical posture, thus dripping in which the liquid drips from the opening at the distal end 4b of the distal end portion 4 is suppressed when the pipette 1 is tilted.

A length of the distal end portion 4 along the distal direction is preferably within a range of 25 mm or more and 60 mm or less, is more preferably within a range of 25 mm or more and 50 mm or less, and is particularly preferably within a range of 25 mm or more and 40 mm or less. If the length of the distal end portion 4 along the distal direction is 25 mm or more, the meniscus of the liquid at the opening at the distal end 4b of the distal end portion 4 becomes unlikely to reach the tapered portion 3 even if the pipette 1 is tilted from the vertical posture, thus the meniscus of the liquid becomes unlikely to break when the pipette 1 is tilted. Therefore, dripping is suppressed when the pipette 1 is tilted. If the length of the distal end portion 4 along the distal direction is 60 mm or less, the increase in the overall length of the pipette 1 along the distal direction is suppressed, thus a deterioration of the operability of the pipette 1 is suppressed.

### EXAMPLES

Hereinafter, examples of the present invention are shown.

(Example 1) Using an urethane acrylate type resin (AR-M2, Keyence) as a material, the pipette 1 having a capacity of 30 ml, an inner diameter of the distal end 2b of the main body portion 2 of 20 mm, a taper angle of the tapered portion 3 of 21 degrees, an inner diameter of the proximal end 3a of the tapered portion 3 of 10 mm, an inner diameter of the distal end 4b of the distal end portion 4 of 3.0 mm, and a length of the distal end portion 4 along the distal direction of 15 mm was produced using a 3D printer (AGILISTA-3200, Keyence).

(Example 2) The pipette 1 was produced in the same manner as in Example 1, except that the length of the distal end portion 4 along the distal direction was set to 20 mm.

(Example 3) The pipette 1 was produced in the same manner as in Example 1, except that the length of the distal end portion 4 along the distal direction was set to 25 mm.

(Example 4) The pipette 1 was produced in the same manner as in Example 1, except that the length of the distal end portion 4 along the distal direction was set to 30 mm.

(Example 5) The pipette 1 was produced in the same manner as in Example 1, except that the length of the distal end portion 4 along the distal direction was set to 40 mm.

(Example 6) The pipette 1 was produced in the same manner as in Example 1, except that the length of the distal end portion 4 along the distal direction was set to 50 mm.

(Example 7) The pipette 1 was produced in the same manner as in Example 1, except that the length of the distal end portion 4 along the distal direction was set to 60 mm.

(Example 8) The pipette 1 was produced in the same manner as in Example 3, except that the inner diameter of the distal end 4b of the distal end portion 4 was set to 3.5 mm.

(Example 9) The pipette 1 was produced in the same manner as in Example 8, except that the length of the distal end portion 4 along the distal direction was set to 30 mm.

(Example 10) The pipette 1 was produced in the same manner as in Example 7, except that the taper angle of the tapered portion 3 was set to 20 degrees and the inner diameter of the proximal end 3a of the tapered portion 3 was set to 20 mm.

(Example 11) The pipette 1 was produced in the same manner as in Example 10, except that the taper angle of the tapered portion 3 was set to 30 degrees.

(Example 12) The pipette 1 was produced in the same manner as in Example 10, except that the taper angle of the tapered portion 3 was set to 40 degrees.

(Comparative Example 1) The pipette 1 was produced in the same manner as in Example 3, except that the inner diameter of the distal end 4b of the distal end portion 4 was set to 2 mm.

(Comparative Example 2) The pipette 1 was produced in the same manner as in Example 3, except that the inner diameter of the distal end 4b of the distal end portion 4 was set to 2.5 mm.

(Comparative Example 3) The pipette 1 was produced in the same manner as in Example 8, except that the length of the distal end portion 4 along the distal direction was set to 15 mm.

(Comparative Example 4) The pipette 1 was produced in the same manner as in Example 8, except that the length of the distal end portion 4 along the distal direction was set to 20 mm.

(Comparative Example 5) The pipette 1 was produced in the same manner as in Example 8, except that the inner diameter of the distal end 4b of the distal end portion 4 was set to 4 mm.

(Comparative Example 6) The pipette 1 was produced in the same manner as in Example 10, except that the taper angle of the tapered portion 3 was set to 50 degrees.

(Dripping test) Internal pressures after discharging the liquid from each pipette 1 of Examples 1, and 3 to 8 and Comparative Examples 1, 2, and 5 were simulated using flow analysis software (Simcenter STAR-CCM+, version 2020.3.1). Concretely, 30 ml of water was suctioned into each pipette 1 and the water was discharged for two seconds at a discharge speed of 10 ml/s, and then the internal pressure of the main body portion 2 of the pipette 1 when the discharge was stopped was calculated, and a judgment was made based on the following criteria. The results are shown in Table 1.

⊚: The internal pressure of the auto pipettor at the time when the discharge of the liquid was stopped was less than 0 mmHg.
◯: The internal pressure of the auto pipettor at the time when the discharge of the liquid was stopped was 0 mmHg or more and less than 5 mmHg.
x: The internal pressure of the auto pipettor at the time when the discharge of the liquid was stopped was larger than 5 mmHg.

(Tilt test) An electric intake and exhaust device 5 (Pipette Aid^{R} XP, 4-040-101-J) was attached to the attachment portion 2c of each pipette 1 of Examples 1 to 4, 8, and 9 and Comparative Examples 1 to 5. The suction/discharge speed of the auto pipettor was set to 10 ml/s. After 10 ml of liquid (purified water) was suctioned into the pipette 1 using the auto pipettor, the pipette 1 was tilted against the vertical direction, and an angle at which the liquid dripped from the opening of the distal end portion 4 was judged visually based on the following criteria. The results are shown in Table 1. Note that a following reference angle of 45 degrees was an angle at which the pipette 1 was normally tilted from a viewpoint of the operator's operability, that is, when the operator suctions and discharges the liquid.

⊚: The tilt angle of the auto pipettor with respect to the vertical direction was larger than the reference angle of 45 degrees by 8 degrees or more.
◯: The tilt angle of the auto pipettor with respect to the vertical direction was larger than the reference angle of 45 degrees by an amount in a range of 2 degrees or more and less than 8 degrees.
Δ: The tilt angle of the auto pipettor with respect to the vertical direction was larger than the reference angle of 45 degrees by an amount in a range of less than 2 degrees.
x: The tilt angle of the auto pipettor with respect to the vertical direction was less than or equal to the reference angle of 45 degrees.

(Blowup test) Statuses of the blowup in which the liquid suctioned into the auto pipettor blew up when the liquid flowed from the distal end portion 4 into the tapered portion 3 after the liquid was suctioned into each pipette 1 of Examples 10 to 12 and Comparative Example 6 were simulated using the flow analysis software (Simcenter STAR-CCM+, version 2020.3.1). Concretely, heights of the liquid blowing up from a water surface when a suction speed was set to 10 ml/s were calculated.

The results are shown in Table 1.
⊚: The height of the liquid blowing up from the water surface was less than 5 mm.
◯: The height of the liquid blowing up from the water surface was 5 mm or more and less than 10 mm.
x: The height of the liquid blowing up from the water surface was 10 mm or more.

TABLE 1

| | Example 1 | Example 2 | Example 3 | Example 4 | Example 5 | Example 6 |
|---|---|---|---|---|---|---|
| Capacity (ml) | 30 | 30 | 30 | 30 | 30 | 30 |
| Inner diameter of main | 20 | 20 | 20 | 20 | 20 | 20 |
| body portion (mm) | | | | | | |
| Taper angle (degree) | 21 | 21 | 21 | 21 | 21 | 21 |
| Inner diameter of | 10 | 10 | 10 | 10 | 10 | 10 |
| tapered portion (mm) | | | | | | |
| Inner diameter of | 3 | 3 | 3 | 3 | 3 | 3 |
| distal end portion (mm) | | | | | | |
| Length of distal end | 15 | 20 | 25 | 30 | 07 | 50 |
| portion (mm) | | | | | | |
| Internal pressure (mmHg) | 0.4 | — | 0.7 | 2.3 | 2.7 | 3 |
| Tilt angle (degree) | 53.5 | 55.8 | 60.5 | 66.4 | — | — |
| Height of blow up (mm) | — | — | — | — | — | — |
| Status of dripping after | ◯ | | ◯ | ◯ | ◯ | ◯ |
| stopping discharge | | | | | | |
| Status of dripping when | ⊚ | ⊚ | ⊚ | ⊚ | | |
| tilted | | | | | | |
| Status of blow up | | | | | | |

| | Example 7 | Example 8 | Example 9 | Example 10 | Example 12 | Example 12 |
|---|---|---|---|---|---|---|
| Capacity (ml) | 30 | 30 | 30 | 30 | 30 | 30 |
| Inner diameter of main | 20 | 20 | 20 | 20 | 20 | 20 |
| body portion (mm) | | | | | | |
| Taper angle (degree) | 21 | 21 | 21 | 20 | 30 | 40 |
| Inner diameter of | 10 | 10 | 10 | 20 | 20 | 20 |
| tapered portion (mm) | | | | | | |
| Inner diameter of | 3 | 3.5 | 3.5 | 3 | 3 | 3 |
| distal end portion (mm) | | | | | | |
| Length of distal end | 60 | 25 | 30 | 60 | 60 | 60 |
| portion (mm) | | | | | | |
| External pressure (mmHg) | 3.7 | −3.4 | — | — | — | — |
| Tilt angle (degree) | — | 48.5 | 51.2 | — | — | — |
| Height of blow up (mm) | — | — | — | 2 | 5 | 8 |
| Status of dripping after | ◯ | ⊚ | | | | |
| stopping discharge | | | | | | |
| Status of dripping when | | ◯ | ◯ | | | |
| tilted | | | | | | |
| Status of blow up | | | | ⊚ | ⊚ | ◯ |

| | Comparative | Comparative | Comparative | Comparative | Comparative | Comparative |
|---|---|---|---|---|---|---|
| | example 1 | example 2 | example 3 | example 4 | example 5 | example 6 |
| Capacity (ml) | 30 | 30 | 30 | 30 | 30 | 30 |
| Inner diameter of main | 20 | 20 | 20 | 20 | 20 | 20 |
| body portion (mm) | | | | | | |
| Taper angle (degree) | 21 | 21 | 21 | 21 | 21 | 50 |
| Inner diameter of | 10 | 10 | 10 | 10 | 10 | 20 |
| tapered portion (mm) | | | | | | |
| Inner diameter of | 2 | 2.5 | 3.5 | 3.5 | 4 | 3 |
| distal end portion (mm) | | | | | | |
| Length of distal end | 25 | 25 | 15 | 20 | 25 | 60 |
| portion (mm) | | | | | | |
| Internal pressure (mmHg) | 34 | 10 | — | — | −5.6 | — |
| Tilt angle (degree) | 53.6 | 62.6 | 45.4 | 46.9 | 35.4 | — |
| Height of blow up (mm) | — | — | — | — | — | 20 |
| Status of dripping after | X | X | | | ⊚ | |
| stopping discharge | | | | | | |
| Status of dripping when | ⊚ | ⊚ | Δ | Δ | X | |
| tilted | | | | | | |
| Status of blow up | | | | | | X |

[Dripping test evaluation] As shown in Table 1, the evaluations were ◯ in all of Examples 1, and 3 to 7, since the internal pressure of the pipette 1 at the time when the discharge of the liquid was stopped was 0 mmHg or more and less than 5 mmHg. This was considered because, since the inner diameter of the distal end 4b of the distal end portion 4 was 3.0 mm, the flow resistance at the distal end 4b did not become large, and at the time when the discharge of the liquid was stopped, the liquid of an expected amount flowed out from the distal end 4b, and as a result, the internal pressure became 0 mmHg or more and less than 5 mmHg, and dripping did not occur.

The evaluation was ⊚ in Example 8, since the internal pressure of the pipette 1 at the time when the discharge of the liquid was stopped was −3.4 mmHg. This was considered because, since the inner diameter of the distal end 4b of the distal end portion 4 was 3.5 mm, the flow resistance at the distal end 4b was smaller than those in Examples 1 to 7 and 10 to 12, and at the time when the discharge of the liquid was stopped, the liquid of the expected amount flowed out from the distal end 4b more quickly, and as a result, the internal pressure became −3.4 mmHg, and dripping did not occur.

On the other hand, the evaluations were x in Comparative Examples 1 and 2, since the internal pressures of the pipette 1 at the time when the discharge of the liquid was stopped were respectively 34 mmHg and 10 mmHg. This was considered because, since in Comparative Examples 1 and 2, the inner diameters of the distal end 4b of the distal end portion 4 were respectively 2 mm and 2.5 mm which were smaller than that in Example 3, the flow resistance at the distal end 4b became large, and at the time when the discharge of the liquid was stopped, a portion of the liquid of the expected amount remained in the pipette 1, and as a result, the internal pressure occurred, and dripping occurred.

From the above, it turned out that if the inner diameter of the distal end 4b of the distal end portion 4 was 3.0 mm or more, dripping did not occur after the discharge of the liquid was stopped.

[Tilt test evaluation] The evaluations were ⊚ in Examples 1 to 4, since the tilt angles of the auto pipettor with respect to the vertical direction were respectively 53.5 degrees, 55.8 degrees, 60.5 degrees, and 66.4 degrees which were larger than the reference angle of 45 degrees by 8 degrees or more. This was considered because, since the inner diameter of the distal end 4b of the distal end portion 4 was 3.0 mm, the meniscus of the liquid at the opening at the distal end 4b of the distal end portion 4 had become unlikely to break.

The evaluations were ◯ in Examples 8 and 9, since the tilt angles of the auto pipettor with respect to the vertical direction were 48.5 degrees and 51.2 degrees which were larger than the reference angle of 45 degrees by amounts in a range of 2 degrees or more and less than 8 degrees. This was considered because, since the inner diameter of the distal end 4b of the distal end portion 4 was 3.5 mm which was larger than those in Examples 1 to 4, the meniscus of the liquid at the opening at the distal end 4b of the distal end portion 4 had become likely to break compared to Examples 1 to 4.

On the other hand, the evaluations were Δ in Comparative Examples 3 and 4, since the tilt angles of the auto pipettor with respect to the vertical direction were respectively 45.4 degrees and 46.9 degrees which were larger than the reference angle of 45 degrees by amounts in a range of less than 2 degrees. This was considered because, although the inner diameter of the distal end 4b of the distal end portion 4 was 3.5 mm which were the same as those in Examples 8 and 9, the length of the distal end portion 4 along the distal direction were 15 mm and 20 mm which were shorter than those in Examples 8 and 9, thus the meniscus of the liquid at the opening at the distal end 4b of the distal end portion 4 was more likely to reach the tapered portion 3 compared to Examples 8 and 9 when the auto pipettor was tilted. Since the inner diameter greatly increases toward the proximal end 3a in the tapered portion 3, the meniscus of the liquid was likely to break when the meniscus of the liquid reaches the tapered portion 3.

On the other hand, the evaluation was x in Comparative Example 5, since the tilt angle of the auto pipettor with respect to the vertical direction was 35.4 degrees which was smaller than the reference angle of 45 degrees. This was considered because, since the inner diameter of the distal end 4b of the distal end portion 4 was 4 mm which was larger than those in Examples 8 and 9, the meniscus of the liquid at the opening at the distal end 4b of the distal end portion 4 had become likely to break compared to Examples 8 and 9.

From the above, it turned out that if the inner diameter of the distal end 4b of the distal end portion 4 was 3.5 mm or less, dripping in which the liquid drips from the opening at the distal end 4b of the distal end portion 4 was almost unlikely to occur when the auto pipettor was tilted.

Furthermore, it turned out that if the inner diameter of the distal end 4b of the distal end portion 4 was the same, as the length of the distal end portion 4 along the distal direction became longer, dripping became more unlikely to occur when the pipette was tilted. This was considered because the meniscus of the liquid at the opening at the distal end 4b of the distal end portion 4 became unlikely to reach the tapered portion 3 when the auto pipettor was tilted.

It turned out that when the inner diameter of the distal end 4b of the distal end portion 4 was 3.5 mm as in Examples 8 and 9 and Comparative Examples 3 and 4, if the length of the distal end portion 4 along the distal direction was 25 mm or more, dripping became unlikely to occur when the pipette was tilted. On the other hand, it turned out that when the inner diameter of the distal end 4b of the distal end portion 4 was 3.0 mm as in Examples 1 to 4, dripping was unlikely to occur when the pipette was tilted even if the length of the distal end portion 4 along the distal direction was only 15 mm as in Example 1.

From the above, it turned out that if the inner diameter of the distal end 4b of the distal end portion 4 was 3.0 mm or more and 3.5 mm or less and the length of the distal end portion 4 along the distal direction was 25 mm or more, dripping did not occur after the discharge of the liquid was stopped, and dripping in which the liquid dripped from the opening at the distal end 4b of the distal end portion 4 was unlikely to occur when the auto pipettor was tilted.

[Blow up test evaluation 1] In Examples 10 to 12, the statuses of the blow up in which the liquid blew up when the liquid suctioned into the pipette 1 flowed from the distal end portion 4 into the tapered portion 3 were evaluated. The evaluations were ⊚ in Examples 10 to 12, since the heights of the liquid blowing up from the water surface were all less than 5 mm. This was considered because, since the taper angles θ of the tapered portion 3 were all 40 degrees or less, the flow resistance of the liquid did not become small rapidly when the liquid suctioned into the auto pipettor flowed from the distal end portion 4 into the tapered portion 3.

On the other hand, the evaluation was x in Comparative Example 6, since the height of the liquid blowing up from the water surface was 10 mm or more. This was considered because, since the taper angle θ of the tapered portion 3 was 50 degrees which was larger than those in Examples 10 to 12, the flow resistance of the liquid became small rapidly when the liquid suctioned into the pipette 1 flowed from the distal end portion 4 into the tapered portion 3.

From the above, it turned out that if the taper angle θ of the tapered portion 3 was 40 degrees or less, the blow up of the liquid did not almost occur when the liquid suctioned into the pipette 1 flowed from the distal end portion 4 into the tapered portion 3.

TABLE 2

| | Exam- | Exam- | Comparative | Comparative |
|---|---|---|---|---|
| | ple 13 | ple 14 | example 7 | example 8 |
| Capacity(ml) | 30 | 30 | 30 | 30 |
| Inner diameter of main | 20 | 20 | 20 | 20 |
| body portion(mm) | | | | |
| Taper angle(degree) | 180 | 180 | 180 | 180 |
| Inner diameter of tapered | 7 | 10 | 3 | 5 |
| portion(mm) | | | | |
| Height of blow up(mm) | 8 | 4 | 43 | 12 |
| Status of blow up | ◯ | ⊚ | X | X |

[Blow up test evaluation 2] In a blow up test evaluation 2, statuses of the blow up in which the liquid suctioned into the pipette 1 blew up when the liquid flowed from the tapered portion 3 into the main body portion 2 were simulated.

(Example 13) The capacity of the main body portion 2 was set to 30 ml, the inner diameter of the distal end 2b of the main body portion 2 was set to 20 mm, the inner diameter of the proximal end 3a of the tapered portion 3 was set to 7.0 mm which was smaller than the inner diameter of the distal end 2b of the main body portion 2, the taper angle θ of the tapered portion 3 was set to 180 degrees, and the suction/discharge speed was set to 10 ml/s. The reason why the taper angle θ was set to 180 degrees was that the tapered portion 3 was substantially omitted, and a status in which the liquid became likely to blow up when the suctioned-up liquid flowed from the tapered portion 3 into the main body portion 2 was assumed regardless of the angle of the taper angle θ. Note that if the tapered portion 3 was substantially omitted, the proximal end 4a of the distal end portion 4 and the proximal end 3a of the tapered portion 3 resulted in a substantial match, however, the inner diameter of the proximal end 3a of the tapered portion 3 was set to 7.0 mm in order to simulate the status of the blow up in which the liquid blew up when the liquid flowed from the tapered portion 3 into the main body portion 2.

(Example 14) The conditions were the same as in Example 13, except that the inner diameter of the proximal end 3a of the tapered portion 3 was set to 10 mm.

(Comparative example 7) The conditions were the same as in Example 13, except that the inner diameter of the proximal end 3a of the tapered portion 3 was set to 3.0 mm.

(Comparative example 8) The conditions were the same as in Example 13, except that the inner diameter of the proximal end 3a of the tapered portion 3 was set to 5.0 mm.

The evaluation was ◯ in Example 13, since the height of the blow up of the liquid from the water surface was 8.0 mm. This was considered because, since the inner diameter of the proximal end 3a of the tapered portion 3 was large, the flow rate of the liquid at the proximal end 3a of the tapered portion 3 was slow, and the blow up of the liquid was suppressed when the suctioned-up liquid flowed from the tapered portion 3 into the main body portion 2.

The evaluation was ⊚ in Example 14, since the height of the blow up of the liquid from the water surface was 4.0 mm.

This was considered because, since the inner diameter of the proximal end 3a of the tapered portion 3 was larger than that in Example 13, the flow rate of the liquid at the proximal end 3a of the tapered portion 3 became slower than that in Example 13, and the blow up of the liquid was further suppressed when the suctioned-up liquid flowed from the tapered portion 3 into the main body portion 2.

The evaluations were x in Comparative Examples 7 and 8, since the heights of the blow up of the liquid from the water surface were respectively 43 mm and 12 mm. This was considered because, since the inner diameter of the proximal end 3a of the tapered portion 3 was smaller than that in Example 13, the flow rate of the liquid at the proximal end 3a of the tapered portion 3 became fast, and the liquid blew up greatly when the suctioned-up liquid flowed from the tapered portion 3 into the main body portion 2.

From the above, it turned out that if the inner diameter of the proximal end 3a of the tapered portion 3 was 7.0 mm or more, the blow up of the liquid can be suppressed regardless of the taper angle θ when the suctioned-up liquid flowed from the tapered portion 3 into the main body portion 2.

### Summary

When the inner diameter of the distal end 4b of the distal end portion 4 is within the range of 3.0 mm or more and 3.5 mm or less, if the length of the distal end portion 4 along the distal direction is 25 mm or more, dripping does not occur after the discharge of the liquid is stopped, and dripping in which the liquid drips from the opening at the distal end 4b of the distal end portion 4 is unlikely to occur when the auto pipettor is tilted. Therefore, it is easy for the operator to perform suction/discharge operations quickly and accurately using the pipette 1.

Furthermore, if the taper angle θ of the tapered portion 3 is 40 degrees or less, the blow up of the liquid can be suppressed when the suctioned-up liquid flows from the distal end portion 4 into the tapered portion 3. Therefore, since adhering of the liquid to the inner surface of the main body portion 2 and generating bubbles can be suppressed, it is easy to obtain the amount of the liquid accurately using the scale of the main body portion 2, or the like.

Furthermore, if the inner diameter of the proximal end 3a of the tapered portion 3 is 7.0 mm or more, the blow up of the liquid can be suppressed when the liquid flows from the tapered portion 3 into the main body portion 2. Therefore, it is easy to obtain the amount of the liquid more accurately with the scale of the main body portion 2, or the like.

### DESCRIPTION OF REFERENCE CHARACTERS

1 pipette
2 main body portion
2a proximal end
2b distal end
2c attachment portion
3 tapered portion
3a proximal end
3b distal end
4 distal end portion
5 intake and exhaust device
θ taper angle

1. A pipette comprising:
a main body portion having a hollow cylindrical shape;
a tapered portion having a hollow cylindrical shape, extending further than a distal end of the main body portion in a distal direction, and having an inner diameter of a proximal end that is less than or equal to an inner diameter of the distal end of the main body portion and an inner diameter decreasing in the distal direction; and
a distal end portion having a hollow cylindrical shape, extending from a distal end of the tapered portion in the distal direction, and having an inner diameter that is less than or equal to an inner diameter of the distal end of the tapered portion.

2. The pipette according to claim 1, wherein the inner diameter of the distal end portion is within a range of 3.0 mm or more and 3.5 mm or less.

3. The pipette according to claim 1, wherein a length of the distal end portion along the distal direction is within a range of 25 mm or more and 60 mm or less.

4. The pipette according to claim 1,
wherein a taper angle of the tapered portion is 40 degrees or less.

5. The pipette according to claim 1,
wherein the inner diameter of the proximal end of the tapered portion is 7.0 mm or more.

6. The pipette according to claim 1,
wherein a capacity of the pipette is within a range of 10 ml or more and 100 ml or less.

7. The pipette according to claim 1,
wherein an attachment portion to which an electric intake and exhaust device can be attached is provided at an end portion of a proximal end side of the main body portion.
